(19) United States
(12) Patent Application Publication
(10) Pub. No.: US 2010/0112387 A1
(43) Pub. Date: May 6, 2010

(54) FUEL CELL MOTOR VEHICLE AND CONTROL METHOD THEREFOR

(75) Inventor: Junji Nagasawa, Numazu-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 12/312,462

(22) PCT Filed: Jul. 24, 2008
(86) PCT No.: PCT/IB2008/001925

§ 371 Date: May 12, 2009

(30) Foreign Application Priority Data
Jul. 26, 2007 (JP) 2007-194936

(51) Int. Cl. H01M 8/04; H01M 2/00; H01M 8/00

(52) U.S. Cl. 429/13; 429/34; 429/25

(57) ABSTRACT

In a motor vehicle equipped with a fuel cell (10), inflow of liquid from outside into the fuel cell (10) is restrained. When it is estimated that there is a risk of liquid flowing into the fuel cell (10) from the gas discharge opening (16) via a gas channel, the exhaust pressure of gas discharged from the gas channel is increased, or passage through the gas channel is shut.

### BACKGROUND OF THE INVENTION

1. Field of the Invention

The invention relates to a motor vehicle in which a fuel cell is mounted, and a control method for the motor vehicle.

2. Description of the Related Art

In the case of a motor vehicle in which a fuel cell is mounted, it is conceivable that a liquid, such as water or the like, flows in from outside through an exhaust opening or the like due to strong rain, submergence of a road, etc. For example, if water flows in, it degrades component members of the fuel cell, or causes a problem in the supply of a reactant gas. Japanese Patent Application Publication No. 2004-319167 (JP-A-2004-319167) discloses that inflow of water into a fuel cell system is prevented by providing an exhaust opening at a position higher than an expected water surface level.

However, in the construction in which the exhaust opening is provided at a high position, the effect of restraining the inflow of water is lost when the water level or the amount of rainfall exceeds the expected range. Thus, this construction alone is not sufficient to restrain the inflow.

### SUMMARY OF THE INVENTION

The invention provides a fuel cell motor vehicle capable of restraining a liquid from flowing into a fuel cell from outside, and a control method for the fuel cell motor vehicle.

A first aspect of the invention is a fuel cell motor vehicle that includes: a gas channel that includes a gas supply channel for supplying a reactant gas to a fuel cell, and an off-gas channel for passing a reaction off-gas discharged from the fuel cell; estimation means for estimating inflow of a fluid into the gas channel from an opening portion of the gas channel; and inflow restraint means for restraining the inflow of the fluid into the fuel cell when the inflow of the fluid is estimated.

According to the first aspect, inflow of fluid into the fuel cell from outside can be restrained.

The first aspect may further include oxidizing gas supply means for supplying an oxidizing gas to the fuel cell. When the inflow of the fluid is estimated, the inflow restraint means continuously may drive the oxidizing gas supply means.

This will continuously discharge gas through the gas discharge opening. In this case, the exhaust flows in such a direction as to force back to the outside the fluid that is about to flow in through the gas discharge opening. Therefore, inflow of fluid through the gas discharge opening can be restrained.

Besides, the first aspect may further include necessary exhaust pressure calculation means for calculating a necessary exhaust pressure of a gas that is necessary in order to restrain inflow of the fluid by exhaust from a gas discharge opening. When the inflow of the fluid is estimated, the inflow restraint means may control the oxidizing gas supply means so that exhaust pressure of an off-gas discharged from gas discharge opening becomes greater than or equal to the necessary exhaust pressure.

With this construction, exhaust continues to be performed at an exhaust pressure that is higher than or equal to the exhaust pressure that is necessary in order to restrain the inflow. Therefore, the inflow of fluid can be effectively restrained.

Besides, the first aspect may further include requested exhaust pressure calculation means for calculating a requested exhaust pressure that is an exhaust pressure of the off-gas discharged from the gas discharge opening when electricity is generated based on a request of the fuel cell motor vehicle; and humidification means for humidifying the fuel cell. When the inflow of the fluid is estimated and the necessary exhaust pressure is higher than the requested exhaust pressure, the inflow restraint means controls the humidification means so that an amount of humidification becomes larger than when the necessary exhaust pressure is less than or equal to the requested exhaust pressure.

This will restrain dryness of the interior of the fuel cell when the inflow of fluid is restrained by using exhaust. Specifically, in the cases where the oxidizing gas caused to flow by the supply means is larger in amount than the oxidizing gas that corresponds to the electricity generation request, the oxidizing gas supplied to the fuel cell sometimes becomes large in amount relative to the amount of electricity generation. In such a case, since the water produced by electricity generation is small in amount relative to the amount of the oxidant gas supplied, the interior of the fuel cell tends to become dry. In this aspect, however, the dryness can be restrained by increasing the amount of humidification.

Besides, the fuel cell motor vehicle may further include: requested exhaust pressure calculation means for calculating a requested exhaust pressure that is an exhaust pressure of the off-gas discharged from the gas discharge opening when electricity is generated based on a request of the fuel cell motor vehicle; a bypass channel that branches from the gas supply channel between the oxidizing gas supply means and the fuel cell and that bypasses the fuel cell and then joins the off-gas channel; and bypass distribution means for distributing an oxidizing gas supplied from the oxidizing gas supply means to the bypass channel and the fuel cell. When the inflow of the fluid is estimated and the necessary exhaust pressure is higher than the requested exhaust pressure, the inflow restraint means may control the bypass distribution means so that a portion of the oxidizing gas passes through the bypass channel.

This will restrain dryness or degradation of the fuel cell in the case where the inflow is restrained by using exhaust. Specifically, in the cases where the oxidizing gas caused to flow by the supply means is larger in amount than the oxidizing gas that corresponds to the electricity generation request, the oxidizing gas supplied to the fuel cell sometimes becomes large in amount relative to the amount of electricity generation. According to this aspect, at least a portion of such a surplus amount of gas passes through the bypass channel, so that the amount of the oxidizing gas supplied to the fuel cell can be brought closer to an appropriate amount that corresponds to the electricity generation. Thus, the load imposed on the fuel cell can be lightened.

Besides, the fuel cell motor vehicle may further include a sealing valve capable of shutting passage through the off-gas channel. When the inflow of the fluid is estimated, the inflow restraint means may control the sealing valve so that passage through the off-gas channel is shut.

With this construction, since passage through the off-gas channel is shut, the inflow of fluid through the gas discharge opening can be physically prevented.

Besides, the fuel cell motor vehicle may further include: oxidizing gas supply means for supplying the fuel cell with an oxidizing gas; electricity generation possibility determination means for determining whether or not it is possible to execute electricity generation of the fuel cell; and necessary exhaust pressure calculation means for calculating a necessary exhaust pressure of a gas that is necessary in order to restrain inflow of the fluid by exhaust from the gas discharge opening When the electricity generation of the fuel cell is possible, the inflow restraint means may discontinue shut of the off-gas channel, and may control the oxidizing gas supply means so that exhaust is performed through the gas discharge opening of the off-gas channel at or above the necessary exhaust pressure.

With this construction, since the shut of passage through the off-gas channel and the restraint of the inflow by the exhaust from the off-gas channel can be selectively used according to circumstances, problems caused by being unable to execute electricity generation can be prevented.

Besides, the fuel cell motor vehicle may further include electric storage means capable of storing electric power generated by the fuel cell, and the electricity generation possibility determination means may determine whether or not it is possible to execute the electricity generation of the fuel cell based on the electricity generation request from the fuel cell motor vehicle and a free storage space of the electric storage means.

This will prevent power shortage in the case where the inflow is restrained.

Besides, in the fuel cell motor vehicle, the gas channel may include: a water discharge opening for discharging a product water produced by the fuel cell; and a water discharge opening sealing valve capable of shutting passage of the fluid through the water discharge opening. When inflow of the fluid is estimated, the inflow restraint means may perform such a control as to close the water discharge opening sealing valve.

This will prevent inflow of fluid through the water discharge opening.

A second aspect of the invention is a fuel cell motor vehicle that includes: a fuel cell; water level detection means for detecting a water level on a road; and inflow restraint means for restraining inflow of fluid into the fuel cell when the water level on the road is higher than or equal to a predetermined value.

This will restrain the inflow in the case where the water level on the road is high.

A third aspect of the invention relates to a control method for a fuel cell motor vehicle. The control method includes: estimating inflow of a fluid into a gas channel from an opening portion of a gas channel that includes a gas supply channel for supplying a reactant gas to a fuel cell and an off-gas channel for passing a reaction off-gas discharged from the fuel cell; and restraining the inflow of the fluid into the fuel cell when the inflow of the fluid is estimated.

According to the third aspect, inflow of fluid into the fuel cell from outside can be restrained.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a diagram showing a construction of Embodiment 1 of the invention;

FIG. 2 is a diagram showing a water level sensor in Embodiment 1 of the invention;

FIG. 3 is a simplified diagram of a fuel cell system in Embodiment 1 of the invention;

FIG. 4 is a flowchart of a control in Embodiment 1 of the invention;

FIG. 5 is a flowchart of a control in Modification 1 of Embodiment 1 of the invention;

FIG. 6 is a diagram showing a water level sensor in a modification of Embodiment 1 of the invention;

FIG. 7 is a diagram showing a water level sensor in another modification of Embodiment 1 of the invention;

FIG. 8 is a flowchart of water level estimation in a modification of Embodiment 1 of the invention;

FIG. 9 is a diagram showing a construction of Embodiment 2 of the invention;

FIG. 10 is a flowchart of a control in Embodiment 2 of the invention;

FIG. 11 is a flowchart of a control in a modification of Embodiment 2 of the invention;

FIG. 12 is a diagram showing a construction of Embodiment 3 of the invention;

FIG. 13 is a flowchart of a control in Embodiment 3 of the invention;

FIG. 14 is a flowchart of a control in a modification of Embodiment 3 of the invention;

FIG. 15 is a diagram showing a construction of Embodiment 4 of the invention; and

FIGS. 16A and 16B are flowcharts of a control in Embodiment 4 of the invention.

### DETAILED DESCRIPTION OF EMBODIMENTS

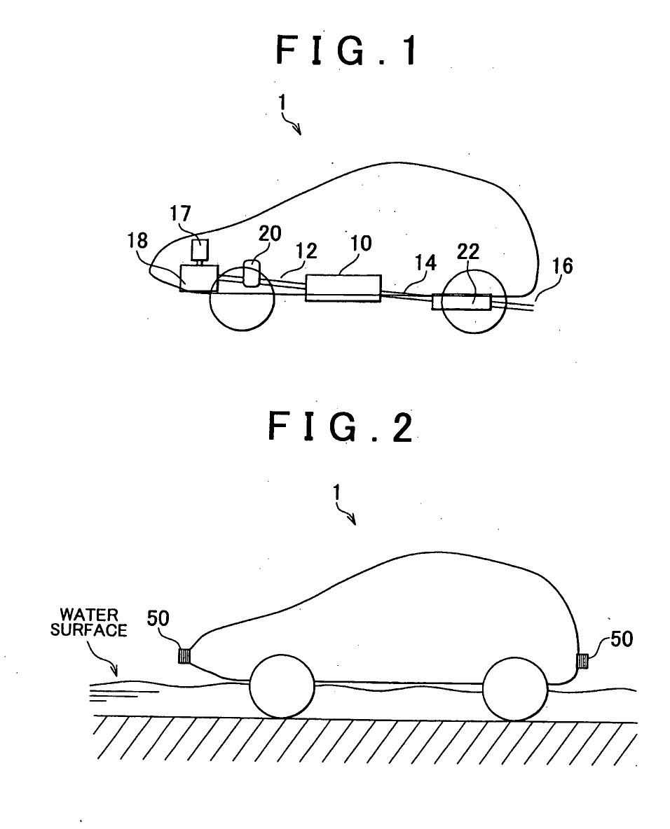

FIG. 1 is a diagram showing a construction of a fuel cell motor vehicle 1 of Embodiment 1. As shown in FIG. 1, the fuel cell motor vehicle 1 is equipped with a fuel cell 10 beneath a floor of the vehicle. The fuel cell 10 generates electricity when supplied with air and hydrogen as reactant gases. In addition, FIG. 1 shows only a supply/exhaust system for air, with a hydrogen supply/exhaust system being omitted. Air is introduced into a compressor 18 from forward of the vehicle through an air cleaner 17. Then, the air is pressurized by the compressor 18, and passes through a gas supply channel 12 to be supplied to the fuel cell 10. The gas supply channel 12 is provided with a humidifier 20 that humidifies the air supplied to the fuel cell 10 so as to adjust the humidity in the fuel cell. Air, after being used for electricity generation within the fuel cell, passes through an off-gas channel 14 to be discharged output from a gas discharge opening 16 provided in a rear of the vehicle.

The off-gas channel 14 descends from upstream to downstream. Therefore, even in the case where liquid flows into the off-gas channel 14 via the gas discharge opening 16, the liquid can be restrained from reaching the fuel cell 10. Besides, in this embodiment, the flow of the exhaust gas restrains inflow of liquid, as described later. The off-gas channel 14 descending from upstream to downstream can lower the pressure of exhaust gas that is needed in order to restrain the inflow of liquid. Therefore, the energy consumed by the compressor 18 can be reduced.

Besides, the off-gas channel 14 is provided with a muffler 22. The muffler 22 is larger in diameter than the off-gas channel 14, and retains therein a sound-absorbing material. Besides, a lower surface of the muffler 22 is lower than lower surfaces of portions of the off-gas channel 14 that are immediately upstream or downstream of the muffler 22. Therefore, an intermediate portion of the off-gas channel 14 has a recess portion that is recessed downward. If liquid flows in from the gas discharge opening 16, the liquid first resides in the recess portion (muffler), and therefore does not immediately flow into the fuel cell 10. Therefore, even if the liquid flows into the off-gas channel before a flow of gas that restrains the inflow of the liquid is produced, the liquid does not reach the fuel cell 10. That is, even if there occurs a response delay to some extent, the inflow of liquid into the fuel cell 10 can be restrained.

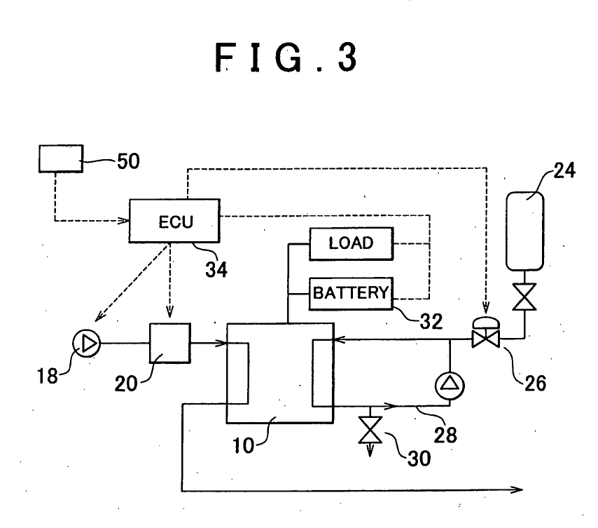

FIG. 2 is a diagram showing an external construction of the fuel cell motor vehicle of Embodiment 1. As shown in FIG. 2, a front and a rear of the fuel cell motor vehicle 1 are each provided with a water level sensor 50. The water level sensors 50 emit ultrasonic waves downward from the vehicle, and measure, from reflected waves, the water level if the road is submerged.

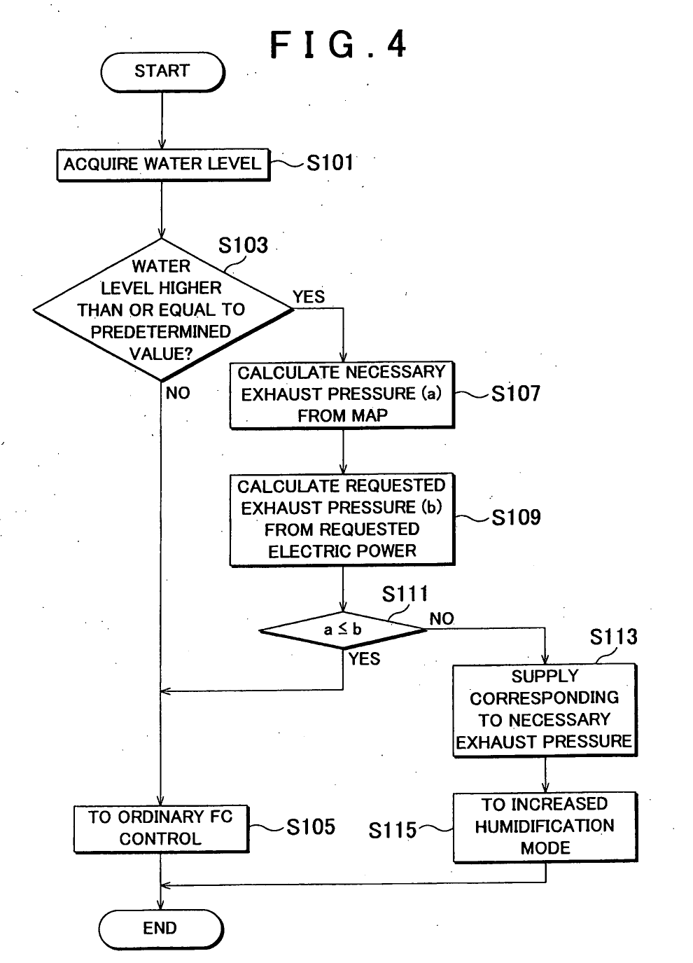

FIG. 3 is a simplified diagram showing a system that is mounted in the fuel cell motor vehicle of Embodiment 1. As shown in FIG. 3, the fuel cell 10 is supplied with hydrogen besides air. Hydrogen is stored in a hydrogen tank 24, and is adjusted to a predetermined pressure by a pressure regulating valve 26, and then is supplied to the fuel cell 10. Hydrogen, after being used for electricity generation in the fuel cell 10, passes through a circulation channel 28 to join together with hydrogen from the hydrogen tank 24, and is supplied again to the fuel cell. The circulation channel 28 has a water discharge opening 30 for discharging to the outside the water produced in the fuel cell 10 in association with the electricity generation, and the water discharge opening 30 is provided with a water discharge valve that is capable of shutting the passage through the water discharge opening 30:

The fuel cell 10 receives air and hydrogen to generate electricity. The electric power obtained is supplied to an electric motor that is a power source of the motor vehicle, and to accessories, a battery 32, etc. An ECU 34 controls the compressor 18 and the humidifier 20 on the basis of the information from the water level sensors 50, etc.,

Incidentally, air may be regarded as an oxidizing gas, and the compressor 18 may be regarded as oxidizing gas supply means, and the battery 32 may be regarded as electric storage means, and the water level sensors may be regarded as water level detection means.

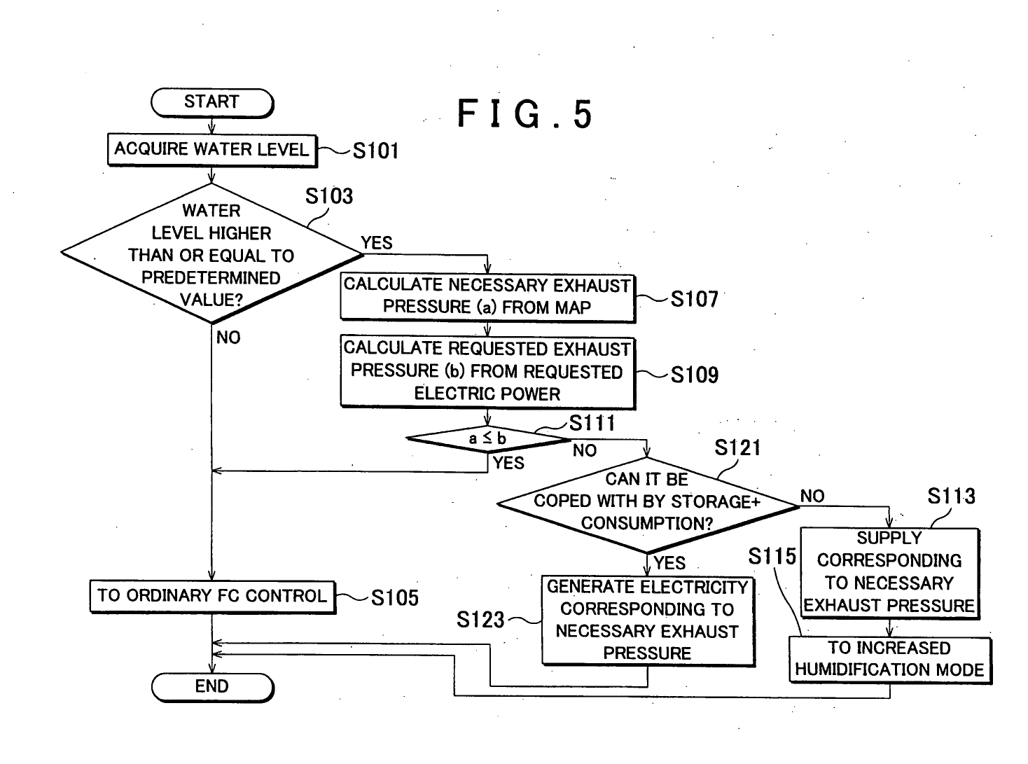

FIG. 4 is a flowchart of a process of Embodiment 1. This process is executed at every predetermined time. The ECU 34 firstly acquires the water level on the road (S101). The water level is measured by the water level sensor 50. Next, the ECU 34 determines whether or not the acquired water level is greater than or equal to a predetermined value (S103). If the water level is less than the predetermined value, it is considered that there is no possibility of the inflow, and the ECU 34 performs an ordinary fuel cell control (S105).

Herein, the ordinary fuel cell control, that is, a control executed in the case where the inflow is not estimated, will be described. In the case where the inflow is not estimated, a request for electricity generation of the fuel cell is made on the basis of the present load and the remaining charge of the battery. Then, the amounts of hydrogen and air corresponding to the electricity generation request are supplied to the fuel cell 10. The amount of air supplied is calculated from the amount of oxygen needed for the electricity generation, the electricity generation efficiency, the electric power consumption of the compressor 18, etc. For example, the compressor 18 is controlled so as to supply an amount of oxygen that is twice the amount of oxygen that is actually consumed. The humidifying condition of the humidifier is controlled so that flooding or dry-up can be prevented under the foregoing conditions. Hereinafter, the electricity generation condition in the case where the inflow is not estimated will be called the ordinary electricity generation condition, and the humidification mode adopted at that time will be called the ordinary humidification mode.

Next, a process in the case where the inflow is estimated will be described. If in step S103 the water level is greater than or equal to the predetermined value, the ECU 34 estimates that liquid will flow in. In that case, the ECU 34 calculates a necessary exhaust pressure (S107). The necessary exhaust pressure herein means a pressure that is needed as the exhaust pressure of the off-gas in the case where the inflow of water is restrained by the exhaust pressure of the off-gas that is discharged from the gas discharge opening 16. The necessary exhaust pressure is calculated by using a map stored in the ECU 34. The map shows the water level and the present necessary exhaust pressure that have been associated in correspondence by experiments beforehand.

Next, the ECU 34 calculates a requested exhaust pressure (S109). Herein, the requested exhaust pressure is the exhaust pressure of exhaust gas that corresponds to the requested electric power in the ordinary electricity generation condition. The requested exhaust pressure is calculated by using a map stored in the ECU 34. The map shows the requested electric power and the corresponding exhaust pressure that have been associated in correspondence.

Next, the ECU 34 compares the calculated necessary exhaust pressure and the calculated requested exhaust pressure (S111). If the requested exhaust pressure is greater than or equal to the necessary exhaust pressure, the ECU 34 performs the ordinary fuel cell control (S105). In this case, the electricity generation based on the requested electric power is performed, so that the exhaust is performed at a pressure that is higher than the exhaust pressure necessary to restrain the inflow. Therefore, the inflow of liquid can be restrained.

If in step S111 the necessary exhaust pressure is greater than the requested exhaust pressure, the compressor 18 is driven so that exhaust pressure becomes equal to the necessary exhaust pressure (S113). At this time, the fuel cell performs electricity generation corresponding to the requested electric power. Specifically, electricity generation is performed with an increased supply of air in comparison with the electricity generation under the ordinary condition. Therefore, exhaust is performed at a pressure that is necessary to restrain the inflow, so that the inflow of liquid can be restrained.

Besides, the humidification mode of the humidifier 20 is changed so that the amount of humidification becomes great than in the ordinary humidification mode (S115). In this case, since the amount of supply of air is increased in comparison with during the electricity generation under the ordinary condition as described above, the proportion of the amount of air flowing in the fuel cell to the amount of water produced by electricity generation has become relatively large. Therefore, it can be said that the fuel cell 10 is in a state in which it tends to be dry. However, dryness can be prevented or restrained since the amount of humidification is increased as described above.

Besides, when the inflow is estimated, the ECU 34 closes the water discharge valve to prevent the drainage from the water discharge opening 30, in parallel with the foregoing process. Therefore, the inflow of liquid through the water discharge opening 30 is also prevented.

Incidentally, in this embodiment, steps S101 and S103 realize inflow estimation means, and steps S113 and S115 realize inflow restraint means.

According to the embodiment, in the case where the inflow of liquid is estimated, the exhaust through the gas discharge opening 16 continues to be performed at the higher one of the necessary exhaust pressure and the requested exhaust pressure. Therefore, since exhaust is continued through the gas discharge opening 16 at a pressure that is higher than or equal to the necessary exhaust pressure, the backflow of liquid through the gas discharge opening 16 can be restrained. As a result, the inflow of liquid into the fuel cell can be restrained.

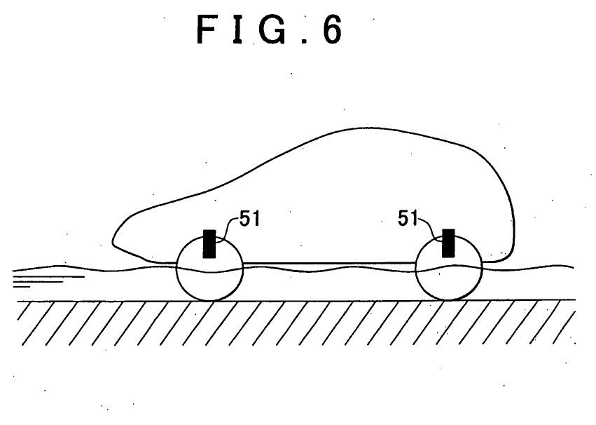

FIG. 5 is a flowchart showing a process in Modification 1 of Embodiment 1. The steps of performing the same processes as in Embodiment 1 are presented with the same reference characters. In this modification, if in step S111 it is determined that the necessary exhaust pressure is higher than the requested exhaust pressure, the ECU 34 determines whether or not the electricity generation can be performed under the ordinary electricity generation condition by increasing the amount of electricity generation (S121). That is, in the case where the amount of electricity generation has increased corresponding to an increase in the amount of supply of air, it is determined whether or not the increased amount of electric power generated can be absorbed by consumption or storage.

In this modification, when a requested electric power is determined, a predetermined free storage space of the battery is left unused such that regenerative electric power can be absorbed. In step S121, it is determined whether or not the increased amount of electric power can be stored by permitting the use of the free storage space of the battery.

If the amount of increase in the electric power generated can be stored, the amount of electricity generation is increased to perform electricity generation (S123). At that time, the amount of increase in the generated electric power is stored into the battery. If the amount of electricity generation cannot be increased, the electricity generation for the requested electric power is performed and the compressor 18 is operated so that the exhaust at the necessary exhaust pressure is achieved (S113) as in Embodiment 1. Besides, the mode of the humidifier 20 is changed to a mode with a large amount of humidification (S115).

If the supply of air is increased, the electric power consumed by the compressor 18 also increases. According to this modification, in the case where the rotation speed of the compressor 18 is to be raised, the production of the necessary exhaust pressure is pursued as much as possible by increasing the amount of electricity generation. Therefore, this modification is advantageous in fuel economy. Besides, the changing of the mode of the humidifier 20 can also be reduced.

Although in Embodiment 1, the necessary exhaust pressure is calculated from the water level and the exhaust continues to be performed at or above the necessary exhaust pressure, this is not restrictive. As long as exhaust continues to be performed, water does not flow into the fuel cell unless water flows against the flow of exhaust gas. Therefore, the continuation of exhaust achieves certain effects. That is, it suffices to prohibit stoppage of the compressor 18. For example, in the case where a process of intermittently stopping the compressor 18 corresponding to the state of operation, it suffices to prohibit this intermittent-stop process. Besides, for example, the necessary exhaust pressure may be set at a predetermined value. In this case, according to the flowchart of the embodiment, the exhaust through the gas discharge opening 16 continues at a pressure that is greater than or equal to the predetermined exhaust pressure. The necessary exhaust pressure may be set at a predetermined value, in other embodiments described below as well.

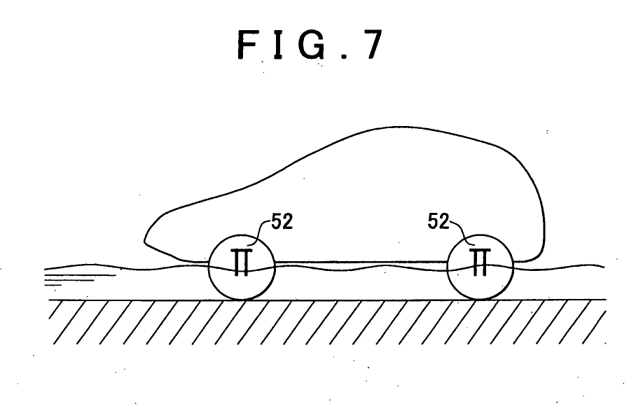

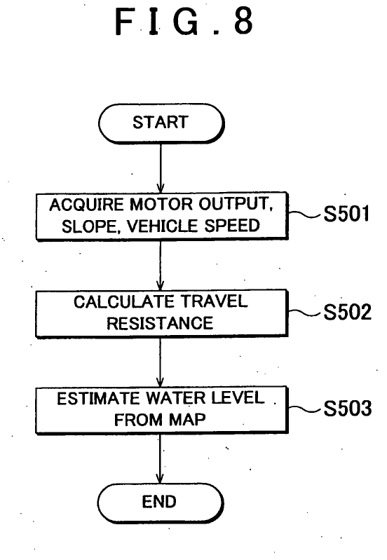

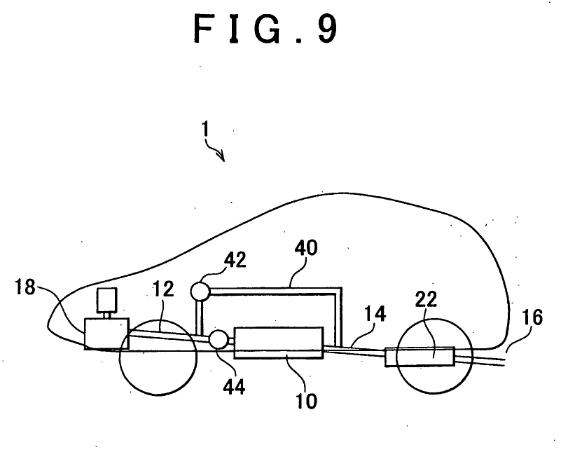

Although in Embodiment 1, the water level sensors that utilize reflection of ultrasonic waves are used to estimate the inflow of liquid, this is not restrictive. Instead of ultrasonic waves, electromagnetic waves may also be emitted. Furthermore, image pickup means, such as a camera or the like, may also be employed. As for the image pickup means, a vehicle-mounted camera for operation assist or drive assist, such as a rear view monitor or the like, may be used. Furthermore, it is permissible to provide sensors 51 that monitor the surroundings of tires or the like as shown in FIG. 6 by image pickup means such as a camera or the like. Besides, sensors 52 that each measure the voltage between two terminals as shown in FIG. 7 may also be employed. Besides, other existing water level meters, such as a float-type water level sensor, a flow meter, etc., may also be employed. It is sufficient if the water level on the road can be measured. Besides, the water level may also be estimated on the basis of the travel resistance as shown in FIG. 8. Specifically, the travel resistance is considered to rise in the case where a road is submerged. Therefore, if a relation between the travel resistance and the water level is found beforehand, the water level can be estimated. Concretely, the travel resistance is calculated from the output of the electric motor, the road gradient, the vehicle speed, etc. (S501 and S502). Then, the water level is estimated from the travel resistance (S503).

Besides, estimation of the inflow that is not based on the water level is also conceivable. For example, the inflow may also be estimated on the basis of the amount of rainfall. Conceivable methods for the estimation based on the amount of rainfall include the employment of a rainfall amount sensor that is used for the control of windshield wipers or the like, the speed of the windshield wipers, the weather information sent to a vehicle-mounted information terminal, such as weather forecast, a weather warning or advisory, etc. In the case where the estimation is based on the amount of rainfall, it suffices that a relation between the amount of rainfall and the possibility of the inflow, and a relation between the amount of rainfall and the necessary exhaust pressure be found and arranged in the form of maps beforehand. That is, any inflow estimation means is sufficient as long as the means is able to estimate the inflow of liquid. This applies to other embodiments as well.

Although in Embodiment 1, the execution of the control of restraining the inflow from the gas discharge opening 16 and the execution of the control of restraining the inflow from the water discharge opening 30 are triggered by the same inflow estimation, this is not restrictive. For example, in the case where the water discharge opening 30 and the gas discharge opening 16 are provided at different heights, inflow may be estimated separately from relations between their respective heights and the water level. It suffices to perform appropriate inflow estimation separately for individual sites that are expected to have inflow. Besides, although in Embodiment 1, the electric storage device is a battery, this is not restrictive. Any storage device is sufficient if the device is able to store electric energy that is generated by the fuel cell. For example, the electric storage device may be a capacitor as well as a secondary cell and the like.

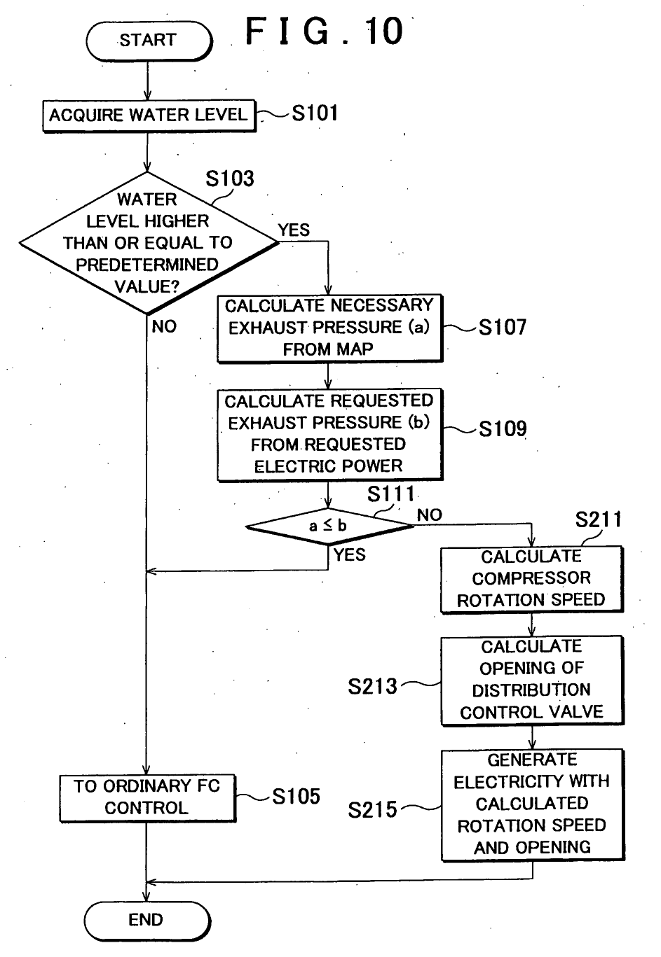

FIG. 9 is a diagram showing a construction of Embodiment 2. The construction of this embodiment is substantially the same as that of Embodiment 1 except for portions particularly described below. The same arrangements and the like in Embodiment 2 as those in Embodiment 1 are presented with the same reference characters. In the fuel cell motor vehicle of Embodiment 2, a bypass channel 40 is provided. The bypass channel 40 is a gas channel that branches from the gas supply channel 12 between the compressor 18 and the fuel cell 10, and that bypasses the fuel cell 10 and joins the off-gas channel 14. The bypass channel 40 is provided with a passage control valve 42. A portion of the gas supply channel 12 that is downstream of the branch point to the bypass channel 40 is provided with a passage control valve 44. In addition, the passage control valves 42, 44 are each capable of controlling or shutting the passage through the channel. When the inflow of liquid is not estimated, the passage control valve 42 is set in a closed state, and the passage control valve 44 is set in an open state. The passage control valves 42, 44 may be regarded as bypass distribution means.

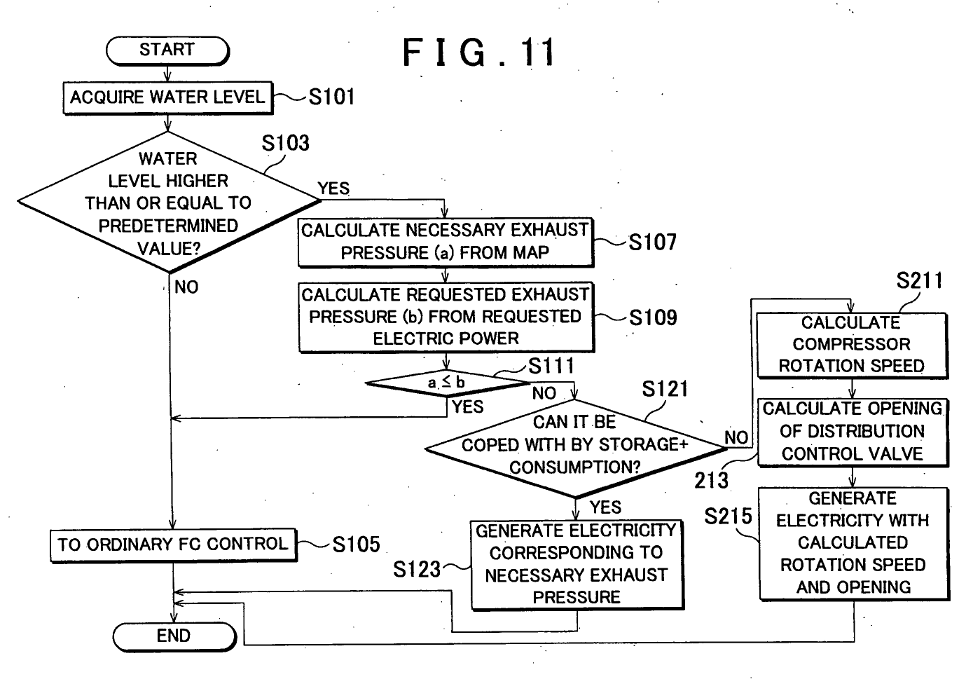

FIG. 10 is a flowchart of a process in Embodiment 2. This process is executed at every predetermined time. As shown in FIG. 10, in Embodiment 2, the necessary exhaust pressure and the requested exhaust pressure are calculated (S107, S109), and are compared with each other in magnitude (S111), as in Embodiment 1. Then, if the requested exhaust pressure is greater than or equal to the necessary exhaust pressure, electricity generation is executed by the ordinary fuel cell control (S105).

If the requested exhaust pressure is less than the necessary exhaust pressure, the fuel cell 10 generates electricity for the requested electric power under the ordinary electricity generation condition, and air is caused to flow through the bypass channel 40 so that the necessary exhaust pressure is discharged. That is, the pressure equivalent to the difference between the necessary exhaust pressure and the requested exhaust pressure is produced by the air passing through the bypass channel 40. The ECU 34 calculates the rotation speed of the compressor 18 and the degree of opening of each of the passage control valves 42, 44 that are necessary to that end (S211, S213). Then, with the calculated rotation speed of the compressor 18 and the calculated opening degrees of the passage control valves 42, 44, the ECU 34 executes electricity generation (S215).

According to the embodiment, in the case where the inflow of liquid is estimated, the exhaust through the gas discharge opening 16 is continued at the higher one of the necessary exhaust pressure and the requested exhaust pressure. This will restrain the backflow of liquid from the gas discharge opening 16 and therefore the inflow thereof into the fuel cell. Besides, the fuel cell 10 is supplied with the amount of air that is necessary under the ordinary electricity generation condition, and the surplus amount of air flows through the bypass channel 40. Therefore, there is no need to change the control mode of the humidifier. Therefore, this embodiment can also be applied to a fuel cell system that is not equipped with a humidifier. This embodiment is the same as the below-described embodiments or modifications in being applicable to a fuel cell system that is not equipped with a humidifier. Furthermore, by closing the passage control valve 44, it is possible to cause the whole air to bypass the fuel cell 10, that is, it is possible to perform the exhaust at the necessary exhaust pressure without supplying air to the fuel cell 10. Therefore, exhaust pressure can be produced without performing electricity generation.

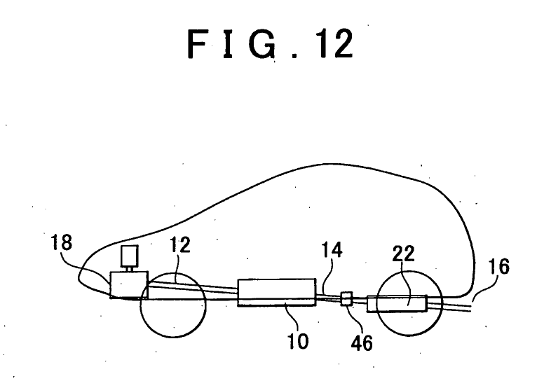

FIG. 11 is a flowchart showing a process of a modification of Embodiment 2. In FIG. 11, the steps of performing the same processes as in Embodiments 1 and 2 or the modifications of Embodiment 1 are presented with the same reference characters. In this modification, in the case where the ECU 34 determines that the amount of increase in electricity generation can be stored, the ECU 34 executes electricity generation with the increased amount of electricity generation (S121, S123), as in Modification 1 of Embodiment 1. In the case where the amount of increase in electricity generation cannot be stored, the amount of air corresponding to the requested electric power under the ordinary electricity generation condition is supplied to the fuel cell 10, and the surplus amount of air by which the necessary amount exceeds the requested amount is caused to bypass, so that the necessary exhaust pressure is produced (S211, S213, S215).

If the supply of air is increased, the electric power consumed by the compressor 18 also increases. According to this modification, the production of the necessary exhaust pressure is pursued as much as possible by increasing the amount of electricity generation. Therefore, this modification is advantageous in fuel economy. Besides, the changing of the mode of the humidifier can be reduced.

Incidentally, the necessary exhaust pressure may also be set as a predetermined value. In that case, it suffices to control the passage control valves 42, 44 so that the fuel cell 10 is supplied with the amount of air that is needed in order to produce the requested electric power, and so that the surplus amount of air is caused to flow through the bypass channel 40.

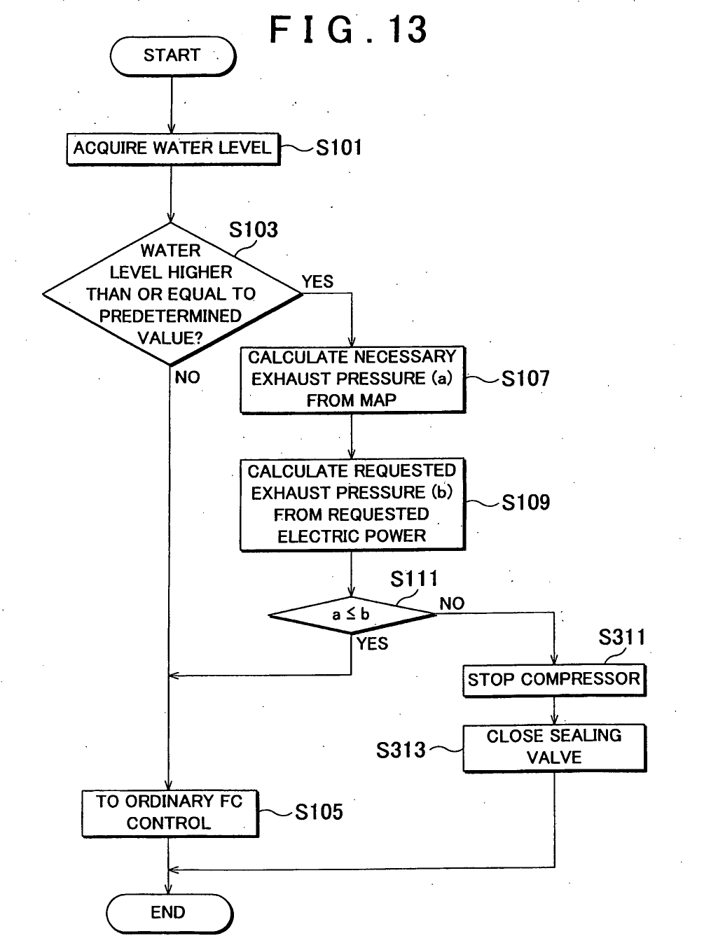

FIG. 12 is a diagram showing a construction of Embodiment 3. The construction of this embodiment is substantially the same as that of Embodiment 1, and the same arrangements and the like as those in Embodiment 1 are presented with the same reference characters. In this embodiment, in the fuel cell vehicle 1, the off-gas channel 14 is provided with a sealing valve 46. The sealing valve 46 is capable of switching the state of off-gas channel between the passage state and the shut state. The operation of the sealing valve 46 is controlled by the ECU 34. Specifically, the sealing valve 46 is set in an open state under the ordinary fuel cell control, and is set in a closed state under a predetermined condition.

Incidentally, the sealing valve 46 is provided at an upstream side (the fuel cell side) of the muffler 22 in the flowing direction of gas. Therefore, the liquid that has flown into the off-gas channel 14 from the gas discharge opening 16, if any, enters the muffler 22 before reaching the sealing valve. Therefore, even if the establishment of the closed state of the sealing valve 46 is delayed due to a response delay or the like, the sealing valve 46 can be caused to be in the closed state before the liquid flows into the side upstream of the sealing valve in the flowing direction of gas. This will more reliably prevent liquid from flowing into the fuel cell 10.

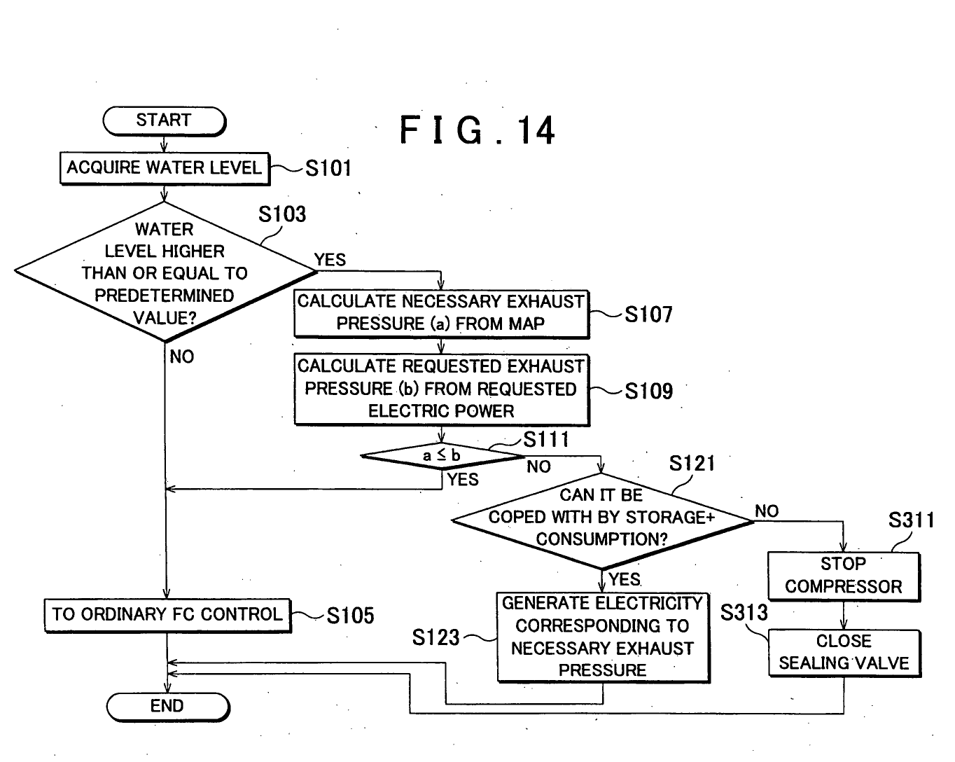

FIG. 13 is a flowchart of a process of Embodiment 3. This process is executed at every predetermined time. As shown in FIG. 13, in Embodiment 3, too, the necessary exhaust pressure and the requested exhaust pressure are calculated (S107, S109), and are compared with each other in magnitude (S111), as in Embodiment 1. Then, if the requested exhaust pressure is greater than or equal to the necessary exhaust pressure, electricity generation is executed by the ordinary fuel cell control (S105).

If the requested exhaust pressure is less than the necessary exhaust, pressure, the compressor 18 is stopped (S311), and the sealing valve 46 is caused to be in the closed state (S313). This shuts the passage through the off-gas channel 14. Since the passage through the off-gas channel 14 is physically shut, the inflow of liquid into the fuel cell 10 through the off-gas channel 14 can be prevented.

Incidentally, in this embodiment, step S111 realizes electricity generation possibility determination means, and it is determined that electricity generation is possible if the requested exhaust pressure is greater than or equal to the necessary exhaust pressure.

According to this embodiment, in the case where the inflow of liquid is estimated, either the passage through the off-gas channel 14 is shut or the exhaust is performed at such an exhaust pressure that the inflow of water can be restrained. Therefore, the inflow of liquid into the fuel cell 10 from the gas discharge opening 16 can be restrained. Besides, in the case where the requested electric power is small, the compressor 18 is stopped, so that the electric power consumed by the compressor can be restrained. In particular, this embodiment is effective in the case where electricity generation is not necessary, for example, in the case where the vehicle is at a stop, or the like.

In the case where the requested exhaust pressure is greater than the necessary exhaust pressure, electricity generation is executed. Since the requested electric power corresponds to the remaining charge of the battery as well, the requested electric power becomes large in the case where the remaining charge of the battery is small even though the load is small. Therefore, executing electricity generation in the case where the requested exhaust pressure is high will prevent the depletion of power.

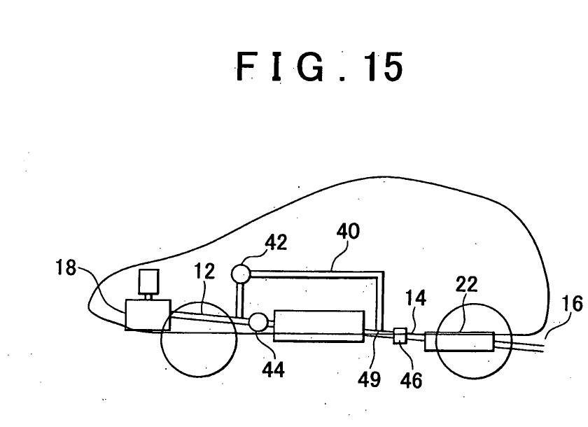

FIG. 14 is a flowchart of a process of a modification of Embodiment 3. The steps of performing the same processes as in Embodiments 1 and 3 or Modification 1 of Embodiment 1 are presented with the same reference characters. In Embodiment 3, in the case where the requested exhaust pressure is smaller than the necessary exhaust pressure, the compressor is always stopped. However, this is not restrictive. In this modification, in the case where the amount of increase in electricity generation can be stored, electricity generation is executed so as to provide the increased amount of electricity (S121, S123), as in Modification 1 of Embodiment 1. In the case where the amount of increase in electricity generation cannot be stored, the compressor 18 is stopped (S311) and the sealing valve 46 is set in the closed state (S313), as in Embodiment 3.

Furthermore, in Embodiment 3, the requested exhaust pressure and the necessary exhaust pressure are compared with each other in magnitude. In the case where the requested exhaust pressure is higher, electricity generation is executed. This is preferable in the light of prevention of an unexpected stop of a motor vehicle. However, this is not restrictive. Specifically, in the case where there is a risk of inflow, the sealing valve 46 may always be closed. This will prevent inflow of liquid into the fuel cell.

Besides, in Embodiment 3, the sealing valve 46 is disposed at the upstream side of the muffler 22. However, the sealing valve is sufficient as long as the valve is able to shut the passage between the fuel cell and the gas discharge opening. For example, the sealing valve may also be provided at the downstream side of the muffler 22. Besides, the sealing valve may also be used in combination with an air shut valve that is provided near a connecting portion between the fuel cell 10 and the off-gas channel 14.

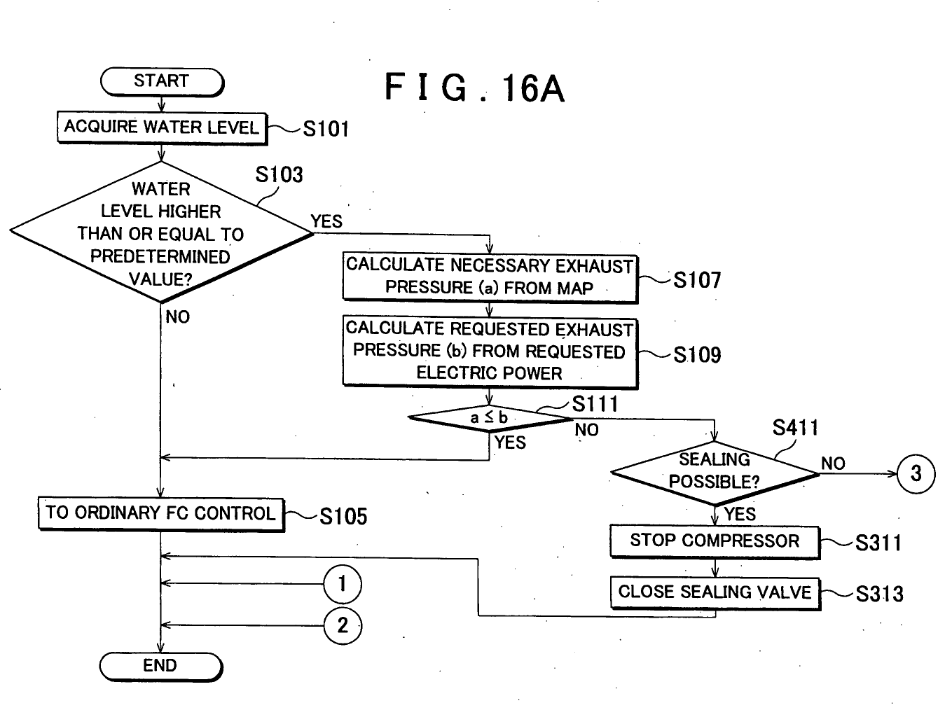

FIG. 15 is a diagram showing a construction of Embodiment 4. The construction of this embodiment is substantially the same as that of Embodiment 1 except for portions particularly described below. The same arrangements and the like as those in Embodiments 1 to 3 are presented with the same reference characters. A fuel cell vehicle 1 is equipped with a bypass channel 40, a sealing valve 46, and passage control valves 42, 44. The sealing valve 46 is provided downstream of a joined portion 49 where the bypass channel 40 and the off-gas channel 14 are joined and upstream of the muffler 22. In the ordinary fuel cell control, the passage control valve 42 is set in the closed state, and the passage control valve 44 and the sealing valve 46 are in the open state. Since the sealing valve 46 is downstream of the joined portion 49, no liquid flows into the bypass channel 40 when the sealing valve 46 is in the closed state. Therefore, the inflow of liquid into the fuel cell 10 through the bypass channel can be prevented.

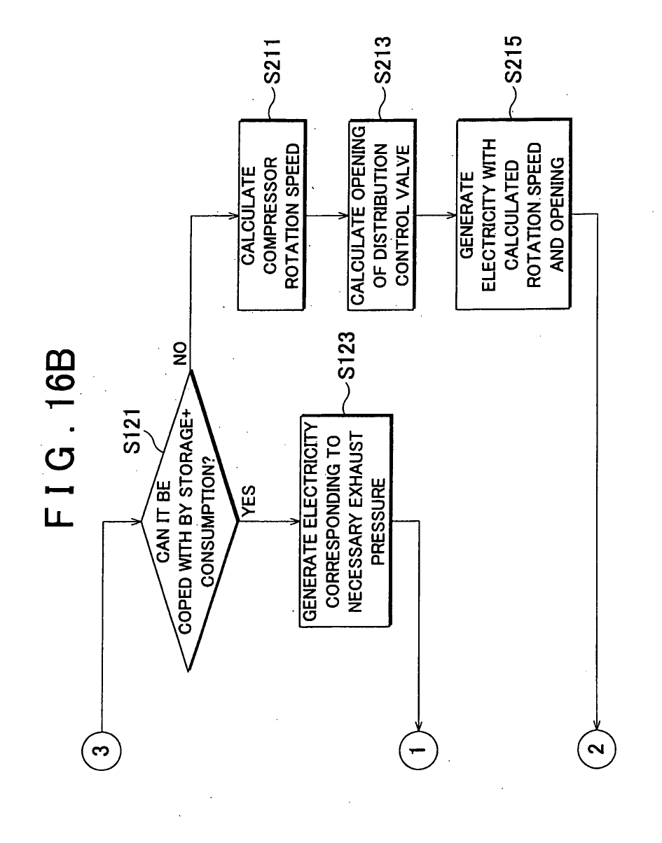

FIGS. 16A and 16B are flowcharts showing a concrete process of Embodiment 4. This process is executed at every predetermined time. As shown in FIGS. 16A and 16B, in Embodiment 4, too, the necessary exhaust pressure and the requested exhaust pressure are calculated (S107, S109), and are compared with each other in magnitude (S111), as in Embodiment 1. Then, if the requested exhaust pressure is greater than or equal to the necessary exhaust pressure, electricity generation is executed by the ordinary fuel cell control (S105).

In the case where the requested exhaust pressure is lower than the necessary exhaust pressure, it is determined whether or not the sealing valve 46 can be closed (S411). If the sealing valve can be closed, the compressor is stopped and the sealing valve 46 is controlled to be in the closed state (S311, S313). In this embodiment, in the case where there is a request for a small amount of electricity generation, it is determined that the sealing valve cannot be closed. For example, in the case where the temperature of the fuel cell is low so that there is a need for warm-up, it can be determined that there is a request for a small amount of electricity generation.

In the case where the sealing valve 46 cannot be closed, the sealing valve 46 is set in the open state, and it is determined whether or not the amount of electricity generation corresponding to the necessary exhaust pressure can be absorbed (S121), similarly to the modification of Embodiment 2 (see FIG. 11). If the aforementioned amount of electricity generation can be absorbed, electricity generation corresponding to the necessary exhaust pressure is performed (S123). If the aforementioned amount of electricity generation cannot be absorbed, the compressor is controlled so that exhaust can be performed at the necessary exhaust pressure, and the distribution valves 42, 44 are controlled so that the surplus amount of air passes through the bypass channel (S211, S213, S215).

According to this embodiment, the inflow of liquid can be restrained. Besides, a request for the small amount can be met while the inflow of liquid is prevented. Specifically, in Embodiment 3, it is difficult to restrain the inflow of fluid while generating a small amount of electricity, whereas in this embodiment, the inflow can be restrained while a small amount of electricity is being generated. Besides, when there is no need for electricity generation, the sealing valve 46 is closed, so that the inflow of fluid can be restrained without energy being consumed by the compressor 18.

By the way, although in Embodiment 4, it is determined whether or not it is possible to perform the sealing by the sealing valve 46 on the basis of a request for a small amount of electricity generation, this is not restrictive. For example, it may be determined that electricity generation is necessary in the case where the state of charge of the battery is less than or equal to a predetermined value.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

1. A fuel cell motor vehicle characterized by comprising:
a gas channel that includes a gas supply channel for supplying a reactant gas to a fuel cell, and an off-gas channel for passing a reaction off-gas discharged from the fuel cell;
estimation means for estimating whether a fluid flows into the gas channel from an opening portion of the gas channel; and
inflow restraint means for restraining inflow of the fluid into the fuel cell when the fluid is estimated to flow in.

2. The fuel cell motor vehicle according to claim 1 further comprising
oxidizing gas supply means for supplying an oxidizing gas as the reactant gas to the fuel cell, wherein when the fluid is estimated to flow in, the inflow restraint means continuously drives the oxidizing gas supply means.

3. The fuel cell motor vehicle according to claim 2 further comprising
necessary exhaust pressure calculation means for calculating a necessary exhaust pressure of a gas that is necessary in order to restrain inflow of the fluid by exhaust from a gas discharge opening of the off-gas channel, wherein when the fluid is estimated to flow in, the inflow restraint means controls the oxidizing gas supply means so that exhaust pressure of an off-gas discharged from gas discharge opening becomes greater than or equal to the necessary exhaust pressure.

4. The fuel cell motor vehicle according to claim 3 further comprising:
requested exhaust pressure calculation means for calculating a requested exhaust pressure that is an exhaust pressure of the off-gas discharged from the gas discharge opening when electricity is generated based on a request of the fuel cell motor vehicle; and
humidification means for humidifying the fuel cell, wherein when the fluid is estimated to flow in and the necessary exhaust pressure is higher than the requested exhaust pressure, the inflow restraint means controls the humidification means so that an amount of humidification becomes larger than when the necessary exhaust pressure is less than or equal to the requested exhaust pressure.

5. The fuel cell motor vehicle according to claim 3 further comprising:
requested exhaust pressure calculation means for calculating a requested exhaust pressure that is an exhaust pressure of the off-gas discharged from the gas discharge opening when electricity is generated based on a request of the fuel cell motor vehicle;
a bypass channel that branches from the gas supply channel between the oxidizing gas supply means and the fuel cell and that bypasses the fuel cell and then joins the off-gas channel; and
bypass distribution means for distributing an oxidizing gas supplied from the oxidizing gas supply means to the bypass channel and the fuel cell, wherein when the fluid is estimated to flow in and the necessary exhaust pressure is higher than the requested exhaust pressure, the inflow restraint means controls the bypass distribution means so that a portion of the oxidizing gas passes through the bypass channel.

6. The fuel cell motor vehicle according to claim 1 further comprising
a sealing valve capable of shutting passage through the off-gas channel, wherein when the fluid is estimated to flow in, the inflow restraint means controls the sealing valve so that passage through the off-gas channel is shut.

7. The fuel cell motor vehicle according to claim 6 further comprising:
oxidizing gas supply means for supplying the fuel cell with an oxidizing gas;
electricity generation possibility determination means for determining whether or not it is possible to execute electricity generation of the fuel cell; and
necessary exhaust pressure calculation means for calculating a necessary exhaust pressure of a gas that is necessary in order to restrain inflow of the fluid by exhaust from the gas discharge opening, wherein when the electricity generation of the fuel cell is possible, the inflow restraint means discontinues shut of the off-gas channel, and controls the oxidizing gas supply means so that exhaust is performed through the gas discharge opening of the off-gas channel at or above the necessary exhaust pressure.

8. The fuel cell motor vehicle according to claim 6 or 7 further comprising
electric storage means capable of storing electric power generated by the fuel cell, wherein the electricity generation possibility determination means determines whether or not it is possible to execute the electricity generation of the fuel cell based on the electricity generation request from the fuel cell motor vehicle and a free storage space of the electric storage means.

9. A fuel cell motor vehicle according to any one of claims 1 to 8 wherein
the gas channel includes:
a water discharge opening for discharging a product water produced by the fuel cell; and
a water discharge opening sealing valve capable of shutting passage of the fluid through the water discharge opening,
wherein when inflow of the fluid is estimated, the inflow restraint means performs such a control as to close the water discharge opening sealing valve.

10. A fuel cell motor vehicle characterized by comprising:
a fuel cell;
water level detection means for detecting a water level on a road; and
inflow restraint means for restraining inflow of water into the fuel cell when the water level on the road is higher than or equal to a predetermined value.

11. A fuel cell motor vehicle control method characterized by comprising:
estimating whether or not a fluid flows into a gas channel from an opening portion of a gas channel that includes a gas supply channel for supplying a reactant gas to a fuel cell and an off-gas channel for passing a reaction off-gas discharged from the fuel cell; and
restraining inflow of the fluid into the fuel cell when the fluid is estimated to flow in.

12. The fuel cell motor vehicle control method according to claim 11 wherein
when the fluid is estimated to flow in, oxidizing gas supply means for supplying an oxidizing gas as the reactant gas to the fuel cell is continuously driven.

13. The fuel cell motor vehicle control method according to claim 12 further comprising
calculating a necessary exhaust pressure of a gas that is necessary in order to restrain the inflow of the fluid by exhaust from a gas discharge opening of the off-gas channel, wherein when the fluid is estimated to flow in, the oxidizing gas supply means is controlled so that an exhaust pressure of the off-gas discharged from the gas discharge opening becomes higher than or equal to the necessary exhaust pressure.

14. The fuel cell motor vehicle control method according to claim 13 further comprising
calculating a requested exhaust pressure that is the exhaust pressure of the off-gas discharged from the gas discharge opening when electricity generation is performed based on a request of the fuel cell motor vehicle,
wherein when the fluid is estimated to flow in and the necessary exhaust pressure is higher than the requested exhaust pressure, the oxidizing gas supplied from the oxidizing gas supply means is distributed to the fuel cell and a bypass channel that branches from the gas supply channel between the oxidizing gas supply means and the fuel cell and that bypasses the fuel cell and joins the off-gas channel in such a distribution manner that a portion of the oxidizing gas passes through the bypass channel.

15. The fuel cell motor vehicle control method according to claim 11 wherein
when the fluid is estimated to flow in, passage through the off-gas channel is shut.
